(19) United States
(12) Patent Application Publication
(10) Pub. No.: US 2022/0253926 A1
(43) Pub. Date: Aug. 11, 2022

(54) PAY-BY-HOUR FACILITY

(71) Applicant: TAISHO SKY BUILDING, INC., Tokyo (JP)

(72) Inventor: Kazuharu ISHIDA, Tokyo (JP)

(21) Appl. No.: 17/660,901

(22) Filed: Apr. 27, 2022

Related U.S. Application Data
(63) Continuation of application No. PCT/JP2019/042725, filed on Oct. 31, 2019.

(51) Int. Cl. G06Q 30/06; G07C 9/00

(52) U.S. Cl. CPC G06Q 30/0645; G07C 9/00904

(57) ABSTRACT

An on-demand rental facility that can improve operational efficiency of a facility by improving convenience for both a reservation person and a user, wherein a management server for managing information on the on-demand rental facility includes: a reservation person receiver that receives an event holding information of an event to be held using the facility from the reservation person, to cause a storage unit to store event holding information; a user receiver that receives user information on the user of the event related to the event holding information from the user, to cause the storage unit to store user information; and a user notifier that notifies the user that the user information has been received. Since the user can directly register the user information, the reservation person does not need to determine the number of users at a time of reservation, and can relatively easily reserve the facility.

### RELATED APPLICATIONS

The present application is a continuation of International Patent Application No. PCT/JP2019/042725, filed Oct. 31, 2019, which is hereby incorporated by reference in its entirety.

### TECHNICAL FIELD

This disclosure relates to an on-demand reservation system for setting a usage time and renting a facility to a user.

### BACKGROUND

A system for renting rooms of a building (e.g., an office, a hotel, or the like) to users typically includes a management server open to a communication network such as the Internet, and a plurality of reservation servers in which information on the conference room is stored. Such a system is typically configured so that users can access information of the conference room in a reservation server via the management server and reserve a desired conference room. Such a system also typically has a billing function so that a rental fee can be paid online.

However, some conventional reservation systems require the number of users and a corresponding rental space size to be known at the time of reservation. In such systems, it may be necessary to recruit users and determine the number of users in advance before the time of reservation, which increases a burden on the reservation organizer who intends to hold an event and makes it difficult for the users who intend to participate in the event to make a participation schedule, resulting in inferior convenience for both the reservation organizer and the users. As a result, operational efficiency of the rental facility may be reduced.

### SUMMARY

An object of the present disclosure is to provide an on-demand reservation system (also referred to as a rental facility) that improves operational efficiency by improving convenience for both the reservation organizer and the users.

The on-demand rental facility of the present disclosure is an on-demand rental facility in which a usage time is set and a facility is rented, including a management server connected to a communication line to manage information of the on-demand rental facility, in which the management server is connected via the communication line to a reservation person input unit that receives information input from a reservation person of the facility to the management server and a user input unit that receives information input from a user of the facility to the management server, and includes: a storage that stores event holding information on a reserved date and time and a reserved location of an event to be held using the facility; a reservation person receiver that receives the event holding information via the reservation person input unit, to cause the storage to store the event holding information; a user receiver that receives user information on the user of the event related to the event holding information via the user input unit, to cause the storage to store the user information; and a user notifier that notifies the user that the user information has been received.

According to the present disclosure as described above, the management server includes: the user receiver that receives the user information on the user of the event via the user input unit, to cause the storage to store the user information; and the user notifier that notifies the user that the user information has been received, so that the user can directly register the user information for the event to be held using the on-demand rental facility. Thus, the reservation person does not need to determine the number of users at the time of reservation, and can relatively easily reserve the facility even when the number of users cannot be predicted. Further, when the user applies for participation in the event via the user input unit, the user can receive the notification from the user notifier of the management server. Therefore, the on-demand rental facility can receive positive holding of the event by the reservation person by improving the convenience for both the reservation person and the user, and can improve the operational efficiency of the facility by enhancing motivation of the users to participate in the event.

At this time, in the present disclosure, it is preferred that the facility is a predetermined space, and the management server includes a user key issuer that issues an unlocking key for unlocking a locking device for the space to the user.

With such a configuration, when the facility is the space, the management server includes the user key issuer that issues the unlocking key for unlocking the locking device for the space to the user, so that the user can unlock the locking device for the space by the issued unlocking key. Therefore, the reservation person does not need to unlock the locking device every time the users enter the event during holding the event, and the on-demand rental facility can further improve convenience for both the reservation person and the user.

Further, in the present disclosure, the management server preferably includes a location information notifier that notifies the user of location information related to a reserved location included in the event holding information stored in the storage.

With such a configuration, the management server includes the location information notifier that notifies the user of the location information related to the reserved location included in the event holding information stored in the storage, so that the user can easily reach the reserved location on the basis of the location information.

Further, in the present disclosure, the management server preferably includes: a registration receiver that receives registration of provided item information on a provided item provided at the event related to the event holding information via the reservation person input unit, to cause the storage to store the provided item information; and an application receiver that receives an application for use of the provided item related to the provided item information via the user input unit.

With such a configuration, the management server includes a registration receiver that receives the registration of the provided item information and the application receiver that receives the application for the use of the provided item, so that the reservation person can register the provided item to be provided to the user, and the user can apply for the use of the provided item.

Further, in the present disclosure, the management server preferably includes: a reservation person side receiver that receives a message of the reservation person via the reservation person input unit; a user side receiver that receives a message of the user via the user input unit; and a message viewer that allows both the reservation person and the user to view the message received by the reservation person side receiver and the user side receiver.

With such a configuration, the management server includes the message viewer that allows both the reservation person and the user to view the message received by the reservation person side receiver and the user side receiver, so that the reservation person and the user can interact with each other by exchanging messages via the management server.

Further, in the present disclosure, the management server preferably includes a usage fee billing part that charges a usage fee for each user with respect to users of the event related to the event holding information.

With such a configuration, the management server includes the usage fee billing part that charges the usage fee of the event for each user with respect to the users of the event to be held using the facility, so that the reservation person can save time and effort of individually billing the user.

Further, in the present disclosure, the management server preferably includes a difference settler that settles a difference obtained by subtracting the usage fee of the facility from sales amount of the event, for the reservation person of the event related to the event holding information.

With such a configuration, the management server includes the difference settler that settles the difference obtained by subtracting the usage fee of the facility from the sales amount of the event, for the reservation person of the event to be held using the facility, so that the reservation person can save the time and effort of individually billing the user and the time and effort of paying the usage fee of the facility.

Further, in the present disclosure, it is preferred that the user receiver causes the storage to store the number of people information including the number of users of the event related to the event holding information, and the management server includes a facility allocator that sets allocation information of the facility on the basis of the event holding information and the number of people information, and causes the user notifier to notify the user of the set allocation information.

With such a configuration, the management server includes the facility allocator that sets the allocation information of the facility on the basis of the event holding information and the number of people information, and causes the user notifier to notify the user of the set allocation information, so that it is possible to allocate appropriate facility according to the number of users. Therefore, the reservation person can relatively easily reserve the facility even when the number of users cannot be predicted at the time of reservation, and can receive the allocation of the facility of an appropriate scale even when the number of users changes. Thus, the on-demand rental facility can receive a positive reservation from the user, and it is expected that the number of repeated users will increase due to improvement of usage satisfaction, so that the operational efficiency can be improved.

At this time, in the present disclosure, it is preferred that the facility allocator allocates at least a part of all available facilities on the basis of the event holding information, the number of people information, and the allocation information, and updates the allocation information on the allocated facility.

With such a configuration, the management server allocates at least a part of all available facilities and updates the allocation information on the allocated facility, so that it is possible to reduce labor costs as compared with a case where the facility is manually allocated, and to immediately update the allocation information and notify the user, when the number of users is changed.

Further, in the present disclosure, it is preferred that the management server is connected via the communication line to a plurality of customer attraction servers that attracts users of the event related to the event holding information and an intermediate server that aggregates customer attraction side reservation information obtained by the customer attraction servers, the customer attraction server includes a customer attraction side reservation part that manages the customer attraction side reservation information on the user and the reserved date and time received from the user, the management server manages the customer attraction side reservation information as the user information, the customer attraction side reservation information being received by the user receiver via the customer attraction server and the intermediate server, and the intermediate server includes: an information obtaining unit that obtains update of the customer attraction side reservation information of the customer attraction server and update of the user information of the management server; and a synchronization control unit that synchronizes the customer attraction side reservation information of the customer attraction server and the user information of the management server on the basis of the customer attraction side reservation information and user information obtained by the information obtaining unit.

With such a configuration, the management server is connected via the communication line to the customer attraction servers and the intermediate server that aggregates the customer attraction side reservation information, and the intermediate server includes: the information obtaining unit that obtains the update of the customer attraction side reservation information of the customer attraction server and the update of the user information of the management server; and a synchronization control unit that synchronizes the customer attraction side reservation information of the customer attraction server and the user information of the management server, so that it is possible to efficiently manage the user information of the users participating in the event by the intermediate server. Therefore, it is not necessary for the management server and the customer attraction server to synchronize the reservation information with each other, and it is possible to suppress processing loads of the servers, and to prevent processing errors and increase certainty of the reservation by synchronizing the user information by the synchronization control unit of the intermediate server.

At this time, in the present disclosure, it is preferred that the facility is a predetermined space, and the intermediate server includes a user key issuer that issues an unlocking key for unlocking a locking device for the space when the update of the customer attraction side reservation information is obtained.

With such a configuration, in the intermediate server, when the facility is the space, the user key issuer issues the unlocking key for unlocking the locking device for the space to be rented, on the basis of the update of the customer attraction side reservation information, so that it is possible to issue the unlocking key to the user even for the reservation from the customer attraction server that does not meet specifications of the locking device for the space to be rented, and to attract a wide range of users regardless of key issuance specifications of the customer attraction servers.

Further, in the present disclosure, the intermediate server preferably includes: a billing amount obtaining unit that obtains a usage fee with respect to the user of the event received via the customer attraction server; and a billing amount counting unit that counts the usage fee obtained by the billing amount obtaining unit.

With such a configuration, in the intermediate server, the billing amount obtaining unit obtains the usage fee with respect to the user of the event received via the customer attraction server, and the billing amount counting unit counts the obtained usage fee, so that an administrator of the on-demand rental facility or an event organizer (the reservation person) can grasp the billing amount for each user, and can grasp counting of the billing amount.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of an on-demand rental facility according to a first embodiment of the present disclosure.

FIG. 2 is a block diagram illustrating a configuration of a management server of the on-demand rental facility in accordance with some implementations.

FIG. 3 is a flowchart illustrating an operation of the management server of the on-demand rental facility in accordance with some implementations.

FIG. 4 is a schematic configuration diagram of the on-demand rental facility according to a second embodiment of the present disclosure.

FIG. 5 is a block diagram illustrating a configuration of the on-demand rental facility in accordance with some implementations.

FIG. 6 is a flowchart illustrating an operation of the on-demand rental facility in accordance with some implementations.

### DETAILED DESCRIPTION

Hereinafter, a first embodiment of the present disclosure will be described with reference to the drawings.

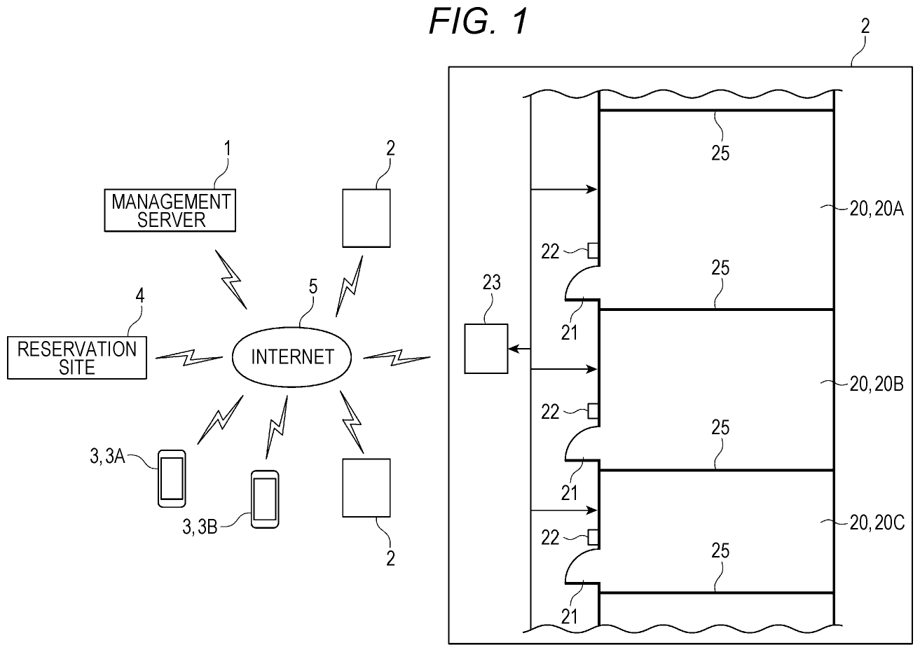

FIG. 1 is a schematic configuration diagram of an on-demand rental facility according to a first embodiment of the present disclosure.

The on-demand rental facility of the present disclosure is a rental space in which a usage time is set and a facility is rented to a user, and as illustrated in FIG. 1, includes a management server 1 for managing the rental space, and a plurality of rooms 20 which is the facility to be rented to the user, and there are a plurality of buildings 2 having the rooms 20. The management server 1, the buildings 2, terminal devices 3 such as a mobile phone, a smart phone, and a personal computer owned by a reservation person and the user, and a reservation site 4 for applying for use of the room 20 can be connected to each other via the Internet 5 which is a public network as a communication line.

The reservation person who intends to reserve the room 20 and hold an event can access the management server 1 via the Internet 5 using a terminal device 3A as a reservation person input unit, search for the room 20 according to a purpose, and reserve the room 20 by designating the usage time, the number of users, and the like. The user who intends to participate in the event can access the reservation site 4 via the Internet 5 using a terminal device 3B as a user input unit and apply for participation in the event. Upon receiving an application from the user, the reservation site 4 transmits reservation information from the terminal device 3B to the management server 1.

The building 2 includes the rooms 20 such as a conference room and a training room, and each room 20 is provided with a doorway 21 and a locking device 22 for locking and unlocking the doorway 21. The locking device 22 can be unlocked by an authentication key such as a password or a bar code issued from the management server 1 to the terminal device 3 of the reservation person and the user, and the authentication key is randomly changed each time it is used, so that only the reservation person who made a reservation at that time and the user can unlock the locking device 22 by using a unique authentication key. A communication terminal device 23 such as a modem or a router is connected to each room 20 via a local area network (LAN), and the communication terminal device 23 is connected to the management server 1 via the Internet 5. Note that in the present embodiment, the password, the bar code, or the like is used as an unlocking key, but for example, biometric authentication such as face authentication, fingerprint authentication, or retina authentication may be used, and any one can be used as long as the locking device 22 can be unlocked. Each room 20 is partitioned by a partition wall 25, and there are a relatively large room 20A, an intermediate size room 20B, and a relatively small room 20C.

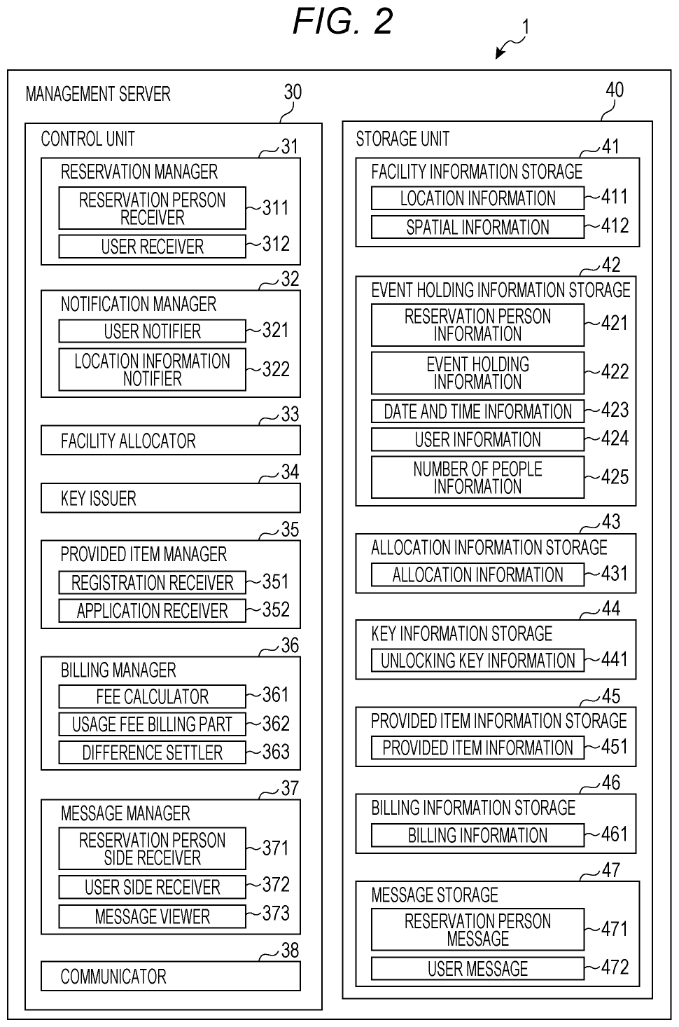

FIG. 2 is a block diagram illustrating a configuration of the management server of the on-demand rental facility.

The management serve 1 includes a server device, and as illustrated in FIG. 2, includes a control unit 30 including a central processing unit (CPU) and the like, and a storage unit (storage) 40 including a storage device such as a hard disk drive (HDD). The control unit 30 includes a reservation manager 31 that manages the reservation information reserved by the reservation person, a notification manager 32 that manages various notifications to the terminal device 3, a facility allocator 33 that allocates the room 20 to be rented on the basis of the reservation information, a key issuer (user key issuer) 34 that issues the unlocking key for unlocking the locking device 22 for the room 20 to the reservation person and the user, a provided item manager 35 that manages provision information on a provided item provided at the event, a billing manager 36 that manages billing information such as a rental fee of the room 20 to be rented, a message manager 37 that manages exchange of messages between the reservation person and the user, and a communicator 38 that controls communication with the communication terminal device 23, the reservation site 4, and the terminal device 3.

The storage unit 40 includes a facility information storage 41 that stores information of all the rooms 20 to be managed, an event holding information storage 42 that stores the event holding information of the event that uses the room 20, an allocation information storage 43 that stores allocation information of the room 20 with respect to the reservation, a key information storage 44 that stores information on the unlocking key to be issued to the reservation person and the user, a provided item information storage 45 that stores the provision information on the provided item to be provided at the event, a billing information storage 46 that stores the billing information such as the rental fee of the room 20 to be rented, and a message storage 47 that stores the messages exchanged between the reservation person and the user. The facility information storage 41 stores location information 411 indicating, for all the rooms 20, an address, access information, and the like of the building 2 in which all the rooms 20 are provided, and a spatial information 412 indicating a room number, a size, use, an accessory device, or the like of each room 20.

Note that the reservation manager 31, the notification manager 32, the facility allocator 33, the key issuer 34, the provided item manager 35, the billing manager 36, the message manager 37, and the communicator 38 may be executed as a program by the CPU of the server device, may be configured by independent devices, or may be configured using cloud computing. Further, the storage unit 40 may be configured by the storage device such as the HDD, or may use a storage unit of a cloud service. Furthermore, the terminal devices 3A and 3B that function as the reservation person input unit and the user input unit may be devices such as a smartphone including an input part that receives input from the reservation person and the user, a display for notifying the reservation person and the user of information, a communicator for transmitting and receiving the information to and from the management server 1, and a controller for controlling the input part, the display, the communicator, and the like, or may be devices in which the input part, the display, the communicator, and the controller are configured by the independent devices.

In the control unit 30, the reservation manager 31 includes a reservation person receiver 311 that receives the event holding information from the terminal device 3A of the reservation person, and a user receiver 312 that receives user information on the user of the event related to the event holding information via the terminal device 3B of the user. Regarding the received event holding information, the reservation person receiver 311 uses information on the reservation person as reservation person information 421, information on event content and the reserved room 20 as event holding information 422, and date and time of the event to be held as date and time information 423, and causes the event holding information storage 42 of the storage unit 40 to store the above information. The user receiver 312 causes the event holding information storage 42 to store the received user information as user information 424, and causes the event holding information storage 42 to store the number of users who have been accepted to participate in the event as the number of people information 425.

The notification manager 32 includes a user notifier 321 that notifies the user that the user information has been received, and a location information notifier 322 that notifies the user of the location information 411 relating to a location of the room 20 included in the event holding information 422. The facility allocator 33 sets the allocation information of the room 20 on the basis of the event holding information 422 and the number of people information 425, and causes the allocation information storage 43 to store the allocation information as allocation information 431. The key issuer 34 issues the unlocking key for the room 20 to be rented, and causes the key information storage 44 to store the unlocking key as unlocking key information 441. The user notifier 321 generates a notification to the user on the basis of the allocation information 431 of the room 20 and the unlocking key information 441, and transmits the notification regarding the room 20 and the unlocking key to the terminal device 3B of the user via the communicator 38. The location information notifier 322 generates a notification to the user on the basis of the location information 411 of the room 20, and transmits the notification of the location information to the terminal device 3B of the user via the communicator 38.

The provided item manager 35 includes a registration receiver 351 that receives registration of the provided item information on the provided item to be provided at the event via the terminal device 3A of the reservation person, and an application receiver 352 that receives an application for use of the provided item related to the provided item information via the terminal device 3B of the user. The registration receiver 351 causes the provided item information storage 45 to store the provided item information received from the reservation person as provided item information 451. Here, examples of the provided item include goods such as equipment used at the event, and electronic data that can be downloaded to the terminal device 3B, and in the case of the goods, they may be delivered to the user in advance, or may be delivered to the room 20 to be used on the day of the event. In addition, the provided item may be sold or rented for a fee, or may be provided without a fee. Then, when the provided item is fee-based, the billing manager 36 may add a fee of the provided item to a usage fee of the event and charge the usage fee to the user, or charge the fee of the provided item to the user by a separate billing unit.

The billing manager 36 causes the billing information storage 46 to store various fees related to rental of the room 20 to be rented to the reservation person and the user as billing information 461. The billing manager 36 includes a fee calculator 361 that calculates the rental fee of the allocated room 20, a usage fee billing part 362 that charges the usage fee for each user with respect to the users of the event, and a difference settler 363 that settles a difference obtained by subtracting the usage fee of the room 20 from sales amount of the event, for the reservation person of the room 20. That is, a participation fee for the event set by an event organizer who is the reservation person of the room 20 is included in the event holding information 422, and the usage fee billing part 362 calculates and charges the participation fee for each event participant who is the user of the room 20. A total of the participation fee calculated in this way is the sales amount of the event. On the other hand, the difference settler 363 subtracts the rental fee of the room 20 from the sales amount of the event, and settles the subtracted difference to the event organizer. Therefore, the event organizer (reservation person) does not need to pay the rental fee of the room 20, and does not need to charge the participation fee to each participant.

The message manager 37 includes a reservation person side receiver 371 that receives a message of the reservation person via the terminal device 3A of the reservation person, a user side receiver 372 that receives a message of the user via the terminal device 3B of the user, and a message viewer 373 that allows both the reservation person and the users to view the message received by the reservation person side receiver 371 and the user side receiver 372. Upon receiving the message of the reservation person from the terminal device 3A, the reservation person side receiver 371 causes the message storage 47 to store the received message as a reservation person message 471. Upon receiving the message of the user from the terminal device 3B, the user side receiver 372 causes the message storage 47 to store the received message as a user message 472. The message viewer 373 generates viewing information of the received message while allowing the reservation person message 471 and the user message 472 to be discriminated from each other, and transmits the viewing information to the terminal devices 3A and 3B of the reservation person and the user via the communicator 38.

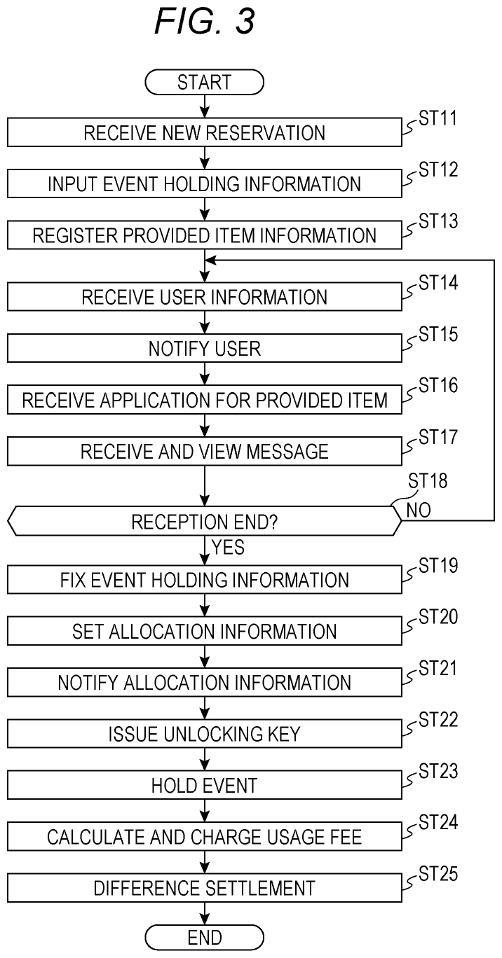

FIG. 3 is a flowchart illustrating an operation of the management server of the on-demand rental facility.

The flowchart of FIG. 3 illustrates an operation procedure of the management server 1 after receiving a new reservation from the reservation person. When the reservation person receiver 311 of the reservation manager 31 receives the reservation from the reservation person (Step ST11), the control unit 30 of the management server 1 causes the event holding information storage 42 to store the reservation person information 421, the event holding information 422, and the date and time information 423 on the basis of the reservation information (Step ST12). Subsequently, in the control unit 30, if the provided item is registered from the terminal device 3A of the reservation person, the registration receiver 351 of the provided item manager 35 receives the registration, and causes the provided item information storage 45 to store the provided item information 451 (Step ST13). From the above, when the event holding using the room 20 is received from the reservation person, the control unit 30 displays the notification of the event to be held, on the reservation site 4, or a predetermined site of the Internet 5 on the basis of the event holding information 422, the date and time information 423, and the provided item information 451.

When the user who has viewed the notification of the event to be held applies for participation from the terminal device 3B, the control unit 30 receives the user information on the user of the event by the user receiver 312, and causes the event holding information storage 42 to store the user information 424 (Step ST14). Further, the user notifier 321 notifies the terminal device 3B of the user that the user information 424 has been received (Step ST15). Further, when the application receiver 352 receives the application for the use of the provided item related to the provided item information 451 via the terminal device 3B, the user information 424 is associated with the provided item information 451 and stored (Step ST16). Further, when the reservation person side receiver 371 and the user side receiver 372 receive the messages from the reservation person and the user via the terminal devices 3A and 3B, the message manager 37 causes the message storage 47 to store the messages as the reservation person message 471 and the user message 472, and the message viewer 373 allows both the reservation person and the users to view the messages (Step ST17). Such message exchange between the reservation person and the user may be continued until the date of the event to be held, or the message exchange can be continued by setting a predetermined period after the event has been held.

Subsequently, the control unit 30 determines whether it is time to end participation reception (Step ST18), and if the participation reception is not ended yet (NO in Step ST18), the control unit 30 repeats Steps ST14 to ST17, to receive application to participate in the event from a plurality of users, and the reservation manager 31 updates the number of people information 425. The control unit 30 ends the reception when a participation reception end time is reached (YES in Step ST18), and fixes the event holding information (Step ST19). Thus, the number of participants (the number of users) of the event is fixed, and the fixed number of people information 425 is stored in the event holding information storage 42. Subsequently, the control unit 30 causes the facility allocator 33 to set the allocation information of the room 20 to be rented on the basis of the event holding information 422, the date and time information 423, the number of people information 425, and the spatial information 412, and causes the allocation information storage 43 to store the allocation information 431 (Step ST20). Specifically, the facility allocator 33 extracts, from the spatial information 412 of all the rooms 20, a room 20 that is vacant at a time of the date and time information 423 and has a size suitable for the event holding information 422 and the number of people information 425, and sets the allocation information 431 as allocating the extracted room 20. For example, the room 20 having an appropriate size is extracted from the rooms 20A to 20C.

When the room 20 is allocated to the event as described above, the control unit 30 causes the notification manager 32 to notify the terminal devices 3A and 3B of the reservation person and the user of the allocation information 431 together with the location information 411 of the building where the room 20 is located (Step ST21). Further, the control unit 30 causes the key issuer 34 to issue the unlocking key for unlocking the locking device 22 for the allocated room 20, causes the key information storage 44 to store the unlocking key as the unlocking key information 441, and causes the notification manager 32 to notify the terminal devices 3A and 3B of the reservation person and the user of the unlocking key information 441 (Step ST22). Note that the unlocking key issued here is changed for each event so that it cannot be unlocked during a period other than the date and time of the event. Further, the unlocking key issued to the reservation person and the unlocking key issued to the user may be the same or different. As an example of different unlocking keys, it is conceivable that the unlocking key of the user can unlock only the locking device 22 for the room 20, whereas the unlocking key of the reservation person can unlock a lock of a warehouse in addition to the locking device 22 for the room 20.

Next, at a predetermined time before the date of the event, the control unit 30 causes the provided item manager 35 to arrange a provided item requested by the user. Specifically, the provided item manager 35 delivers the provided item to a user's residence through a contracted seller or rental company, delivers the provided item to the building with the reserved room 20, or stores electronic data in a storage area of a predetermined site or cloud service that exists in the Internet 5, so that the electronic data can be viewed by the user. Subsequently, on the date of the event, the control unit 30 monitors an unlocking operation of the locking device 22 for the room 20 by the unlocking key notified to the reservation person and the user, detects that the event has started or the event has ended, and disables the unlocking key by the key issuer 34 after the event has ended (Step ST23).

When the event using the room 20 has ended as described above, the control unit 30 calculates and charges the usage fee to the reservation person and the user by the billing manager 36 on the basis of the rental fee of the room 20 to the reservation person and the participation fee for each user. Here, first, the usage fee billing part 362 calculates the participation fee for each user on the basis of the participation fee for the event (lesson fee, lecture fee, or the like), a price of the provided item, or the like, and charges the participation fee to the users (Step ST24). Subsequently, the control unit 30 causes the difference settler 363 to calculate the difference obtained by subtracting the rental fee of the room 20 from the sales amount of the event, which is the total of the participation fee for the event charged to the user, and when the difference is positive, the difference is paid to the reservation person, and when the difference is negative, the difference is charged to the reservation person (Step ST25). Further, regarding the price of the provided item charged to the user, a payment process is performed in which if a provider of the provided item is the reservation person oneself, the price is paid to the reservation person, and if the provider of the provided item is the seller, the price is paid to the seller.

From the above, processing of the management server 1 regarding the rental of the room 20 is completed, and the control unit 30 waits for reception of a next reservation. Note that in Step ST17, if it is set that the exchange of messages can be continued for a predetermined period after the event is held, the control unit 30 continuously executes only the above-described processing by the message manager 37.

According to the present embodiment as described above, the following operations and effects can be obtained.

(1) The control unit 30 of the management server 1 includes: the user receiver 312 that receives the user information on the user of the event via the terminal device 3B of the user, to cause the event holding information storage 42 to store the user information 424; and the user notifier 321 that notifies the user that the user information 424 has been received, so that the user can directly register the user information 424 for the event to be held using the on-demand rental facility. Thus, the reservation person does not need to determine the number of users at the time of reservation, and can relatively easily reserve the room 20 even when the number of users cannot be predicted. Further, when the user applies for participation in the event via the terminal device 3B, the user can receive the notification from the user notifier 321 of the management server 1. Therefore, the on-demand rental facility can receive positive holding of the event by the reservation person by improving convenience for both the reservation person and the users, and can improve operational efficiency of the facility by enhancing motivation of the users to participate in the event.

(2) The control unit 30 of the management server 1 includes the key issuer 34 that issues the unlocking key for unlocking the locking device 22 for the room 20 to the user, so that the user can unlock the locking device 22 for the room 20 by the issued unlocking key. Therefore, the reservation person does not need to unlock the locking device 22 every time the users enter the event during holding the event, and the on-demand rental facility can further improve the convenience for both the reservation person and the users.

(3) The control unit 30 of the management server 1 includes the location information notifier 322 that transmits to the user the location information 411 related to the room 20 and the building 2 included in the event holding information 422 stored in the event holding information storage 42, so that the user can easily reach the building 2 and the room 20 on the basis of the location information 411.

(4) The control unit 30 of the management server 1 includes the registration receiver 351 that receives the registration of the provided item information 451 from the reservation person, and the application receiver 352 that receives the application for the use of the provided item from the user, so that the reservation person can register the provided item to be provided to the user, and the user can apply for the use of the provided item.

(5) The control unit 30 of the management server 1 includes the message viewer 373 that allows both the reservation person and the users to view the message received by the reservation person side receiver 371 and the user side receiver 372, so that the reservation person and the user can interact with each other by exchanging the messages via the management server 1.

(6) The control unit 30 of the management server 1 includes the usage fee billing part 362 that charges the usage fee of the event for each user with respect to the users of the event to be held using the room 20, so that the reservation person can save time and effort of individually billing the user.

(7) The control unit 30 of the management server 1 includes the difference settler 363 that settles the difference obtained by subtracting the usage fee of the room 20 from the sales amount of the event, for the reservation person of the event to be held using the room 20, so that the reservation person can save the time and effort of individually billing the user and the time and effort of paying the usage fee of the room 20.

(8) The control unit 30 of the management server 1 includes the facility allocator 33 that sets the allocation information 431 of the room 20 on the basis of the event holding information 422 and the number of people information 425, and causes the user notifier 321 to notify the user of the set allocation information 431, so that it is possible to allocate the room 20 having a suitable size according to the number of users. Therefore, the reservation person can relatively easily reserve the room 20 even when the number of users cannot be predicted at the time of reservation, and can receive the allocation of the room 20 of an appropriate scale even when the number of users changes. Thus, the on-demand rental facility can receive a positive reservation from the user, and it is expected that the number of repeated users will increase due to improvement of usage satisfaction, so that the operational efficiency can be improved.

(9) The facility allocator 33 of the control unit 30 allocates at least a part of all available rooms 20 and updates the allocation information 431 on the allocated room 20, so that it is possible to reduce labor costs as compared with a case where the room 20 is manually allocated, and to immediately update the allocation information 431 and notify the user, when the number of users changes.

### Second Embodiment

Hereinafter, a second embodiment of the present disclosure will be described with reference to the drawings.

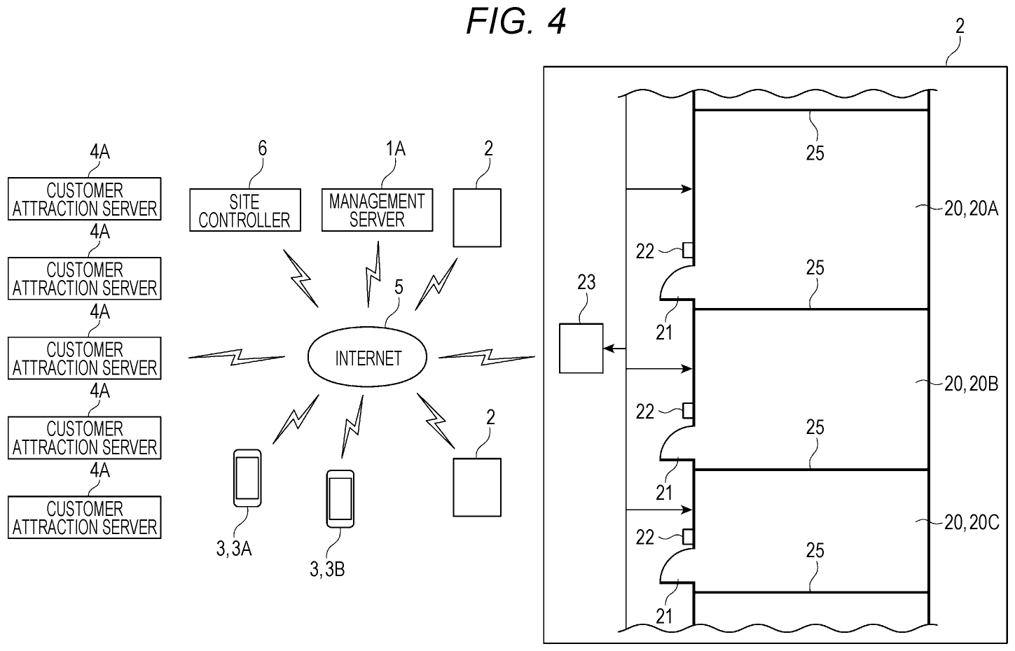

FIG. 4 is a schematic configuration diagram of the on-demand rental facility according to the second embodiment of the present disclosure.

As illustrated in FIG. 4, the on-demand rental facility of the present embodiment includes a management server 1A for managing the rental space as the on-demand rental facility, and the rooms 20. The management server 1A is connected to each other via the Internet 5 with the terminal devices 3A and 3B of the reservation person and the user, a plurality of customer attraction servers 4A that attracts the users of the rental space, and a site controller 6 that is an intermediate server for aggregating the customer attraction side reservation information obtained by the customer attraction servers 4A.

In the on-demand rental facility of the present embodiment, as in the above embodiment, the reservation person who reserves the room 20 which is the facility and holds the event accesses the management server 1A via the Internet 5 using the terminal device 3A, and makes a reservation for the room 20 according to a purpose of the event. On the other hand, the user who intends to participate in the event can access an arbitrary customer attraction server 4A via the Internet 5 using the terminal device 3B and apply for participation in the event. The customer attraction server 4A receives the event holding information and the billing information such as the participation fee for the event from the management server 1A and the site controller 6, and discloses the event holding information and the billing information, and upon receiving a participation application from the user, the customer attraction server 4A transmits the customer attraction side reservation information to the site controller 6 and the management server 1A.

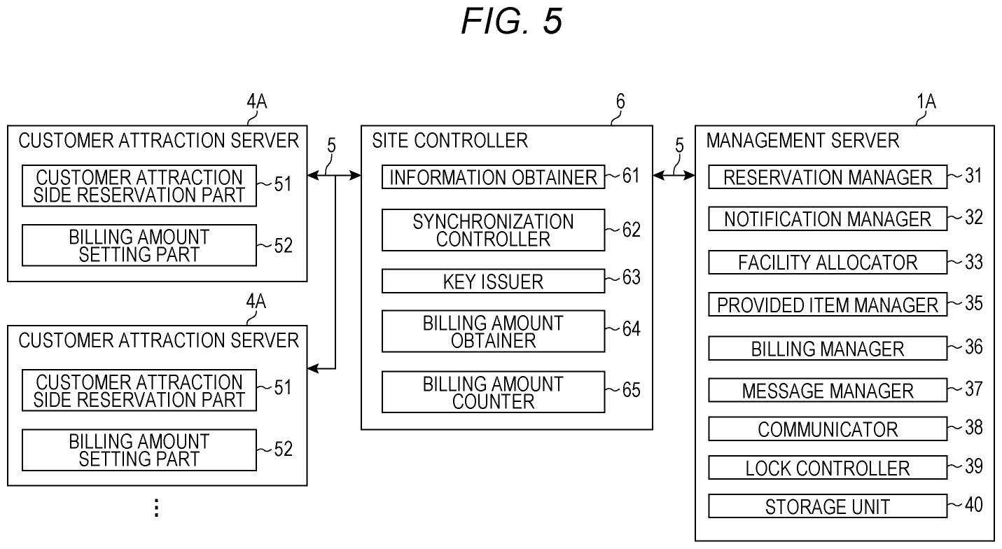

FIG. 5 is a block diagram illustrating a configuration of the on-demand rental facility of the second embodiment.

The management server 1A includes, substantially similar to the management server 1 of the first embodiment, the reservation manager 31 that manages the reservation information from the reservation person and the user, the notification manager 32 that manages various notifications to the terminal device 3, the facility allocator 33 that allocates the room 20 to be rented on the basis of the reservation information, the provided item manager 35 that manages the provision information on the provided item to be provided at the event, the billing manager 36 that manages the billing information such as the rental fee of the room 20 to be rented, the message manager 37 that manages the exchange of the messages between the reservation person and the user, and the communicator 38 that controls the communication with the terminal device 3, the customer attraction server 4A, and the site controller 6. Further, the management server 1A includes: a lock controller 39 that controls the locking device 22 for the room 20; and the storage unit (storage part) 40, communicates with the site controller 6 via the Internet 5, to transmit and receive room information, the reservation information, billing conditions, the unlocking key information, or the like, and communicates with the communication terminal device 23 of the building 2, to transmit and receive a control signal of the locking device 22.

Each of the customer attraction servers 4A includes the server device having a controller including the central processing unit (CPU) and the like, discloses the event holding information and the billing information related to the event to be held, and receives the application for the use from the terminal device 3B of the user via the Internet 5. The customer attraction server 4A includes a customer attraction side reservation part 51 that manages the customer attraction side reservation information on the user received, and a billing amount setting part 52 that sets various billing amounts such as the participation fee for the event for which the reservation is received. Further, although not illustrated, the customer attraction server 4A includes the storage unit for storing various information, a communication unit for communicating with the site controller 6 and the terminal device 3, an input unit for the administrator to input settings, and the like. The customer attraction server 4A communicates with the terminal device 3B of the user via the Internet 5, to transmit and receive the reservation information and the billing information, and communicates with the site controller 6, to transmit and receive the reservation information, the billing information, and the like.

The site controller 6 includes the server device having the controller including the central processing unit (CPU) and the like, and includes an information obtainer 61 that obtains the reservation information from the management server 1A and the customer attraction server 4A, a synchronization controller 62 that synchronizes the reservation information between the management server 1A and the customer attraction server 4A, a key issuer (user key issuer) 63 that issues the unlocking key for unlocking the locking device 22 for the room 20 to be rented to the user, a billing amount obtainer 64 that obtains various billing amounts such as the participation fee for the event set by the customer attraction server 4A, and a billing amount counter 65 that counts the billing amounts obtained by the billing amount obtainer 64. Further, although not illustrated, the site controller 6 includes the storage unit for storing various information, the communication unit for communicating with the management server 1A and the customer attraction server 4A, the input unit for the administrator to input settings, and the like. Note that functions of parts of the customer attraction server 4A and the site controller 6 may be executed as the program by the CPU of the server device, may be configured by independent devices, or may be configured using cloud computing.

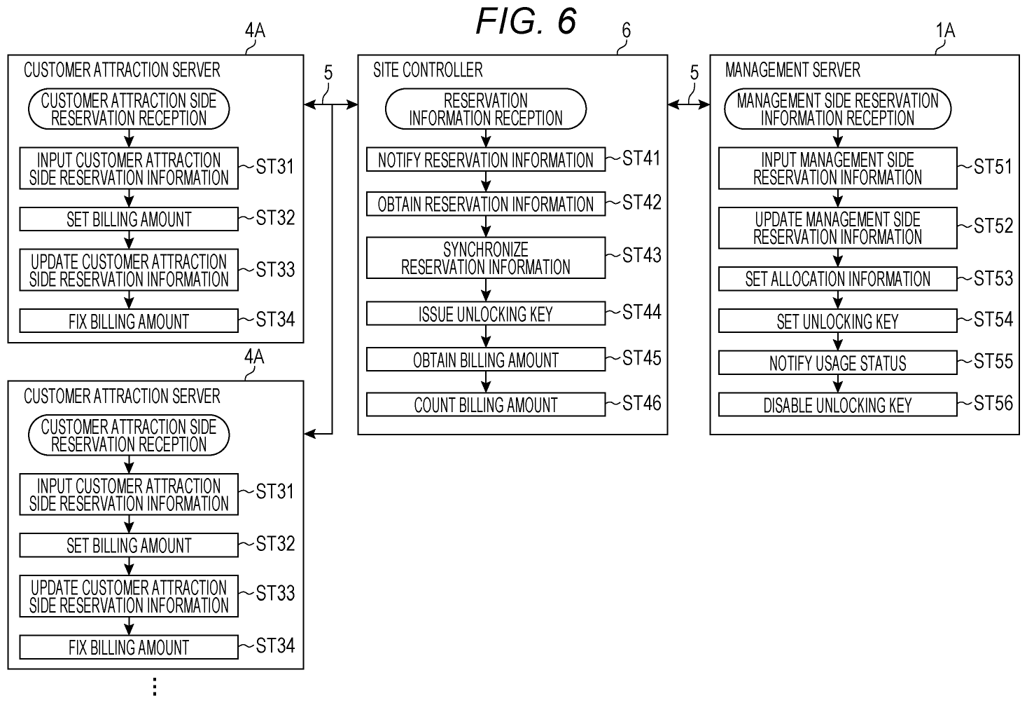

FIG. 6 is a flowchart illustrating an operation of the on-demand rental facility of the second embodiment.

In the flowchart of FIG. 6, the event holding information is registered in the management server 1A by the reservation person, and in a situation where the event holding information is disclosed by the customer attraction server 4A, an operation procedure of the customer attraction server 4A, the site controller 6, and the management server 1A after receiving the application to participate in the event from the user is illustrated. Note that the flowchart of FIG. 6 describes a rough processing flow of the customer attraction server 4A, the site controller 6, and the management server 1A, and details such as repetitive processing will be omitted. First, when any one of the customer attraction servers 4A receives a reservation for the application to participate in the event via the Internet 5 from the terminal device 3B of the user, the customer attraction side reservation part 51 causes the storage unit to store the customer attraction side reservation information including the user information, and transmits the customer attraction side reservation information to the site controller 6 (Step ST31). Further, the customer attraction server 4A sets the billing amount as the participation fee for the event by the billing amount setting part 52 on the basis of the customer attraction side reservation information and the billing conditions, and transmits the billing amount together with the customer attraction side reservation information to the terminal device 3B of the user (Step ST32).

When the information obtainer 61 receives the reservation information from the customer attraction server 4A, the site controller 6 transmits the reservation information to the management server 1A, and the customer attraction servers 4A other than the customer attraction server 4A that has received the reservation (Step ST41). When the management server 1A receives the reservation information from the site controller 6, the reservation manager 31 causes the storage unit 40 to store the reservation information as management side reservation information (Step ST51). Further, when the other customer attraction servers 4A receive the reservation information from the site controller 6, the customer attraction side reservation part 51 causes the storage unit to store the reservation information as the customer attraction side reservation information (Step ST31). From the above, the customer attraction side reservation information stored in all the customer attraction servers 4A and the management side reservation information stored in the management server 1A match each other.

Subsequently, when the customer attraction server 4A receives change of the reservation from the terminal device 3B of the user, the customer attraction side reservation part 51 stores and updates the customer attraction side reservation information in the storage unit, and transmits update of the customer attraction side reservation information to the site controller 6 (Step ST33). Here, if there is change in the billing amount, the customer attraction server 4A may perform Step ST32 again to reset the billing amount. When the site controller 6 obtains the update of the customer attraction side reservation information in the customer attraction server 4A (Step ST42), the synchronization controller 62 synchronizes the updated customer attraction side reservation information with the management side reservation information of the management server 1A, and the customer attraction side reservation information of the other customer attraction servers 4A, and the site controller 6 transmits the reservation information to the management server 1A and the other customer attraction servers 4A (Step ST43).

When the management server 1A receives the updated reservation information from the site controller 6, the reservation manager 31 stores and updates the reservation information as the management side reservation information in the storage unit 40 (Step ST52). When the other customer attraction servers 4A receive the updated reservation information from the site controller 6, the customer attraction side reservation part 51 stores and updates the reservation information as the customer attraction side reservation information in the storage unit (Step ST33). From the above, even when the reservation information is updated on the customer attraction server 4A side, the customer attraction side reservation information stored in all the customer attraction servers 4A and the management side reservation information stored in the management server 1A match each other.

On the other hand, when the reservation information is updated on the management server 1A side, the reservation manager 31 stores and updates the reservation information as the management side reservation information in the storage unit 40, and transmits update of the management side reservation information to the site controller 6 (Step ST52). When the site controller 6 obtains the update of the management side reservation information in the management server 1A (Step ST42), the synchronization controller 62 synchronizes the updated management side reservation information with the customer attraction side reservation information of all the customer attraction servers 4A, and transmits the reservation information to all the customer attraction servers 4A (Step ST43). When all the customer attraction servers 4A receive the updated reservation information from the site controller 6, the customer attraction side reservation part 51 stores and updates the reservation information as the customer attraction side reservation information in the storage unit (Step ST33). From the above, even when the reservation information is updated on the management server 1A side, the management side reservation information stored in the management server 1A and the customer attraction side reservation information stored in all the customer attraction servers 4A match each other.

Note that in the present embodiment, the management server 1A does not receive a new reservation for an event from the user, but may be configured to receive the new reservation. In this case, it is configured such that the site controller 6, the management server 1A, and the customer attraction server 4A operate in the same manner as when the reservation information is updated on the management server 1A side as described above, and the management side reservation information stored in the management server 1A and the customer attraction side reservation information stored in all the customer attraction servers 4A match each other.

When the event holding information 422 and the number of people information 425 are fixed after a participation application period for the event has passed, the management server 1A sets the allocation information of the room 20 to be rented by the facility allocator 33 on the basis of the fixed management side reservation information, and transmits the set allocation information to the site controller 6 (Step ST53). Specifically, the facility allocator 33 extracts, from all available rooms 20, a room 20 that is vacant at a date and time of use and has a size suitable for the number of users, and sets the allocation information 431 as allocating the extracted room 20. Note that in the management server 1A, the allocation of the room 20 is not limited to being performed after the participation application period for the event has passed, and may be performed at any timing. On the other hand, when the site controller 6 receives the allocation information 431, the key issuer 63 issues the unlocking key for unlocking the locking device 22 for the room 20 to be rented, associates the unlocking key with the reservation information, and transmits it to the terminal devices 3A and 3B of the reservation person and the user, and the management server 1A (Step ST44).

Subsequently, when an event holding time of an event holding date approaches (for example, 10 minutes before a start time), in the management server 1A, the lock controller 39 controls and enables the locking device 22 for the room 20 rented to be unlocked on the basis of the unlocking key received from the site controller 6 (Step ST54). Thus, the reservation person and the user can unlock the locking device 22 for the room 20 by using the unlocking key received from the site controller 6 to the terminal devices 3A and 3B. The management server 1A detects a usage status of the room 20 using a motion sensor or the like (not illustrated), and when the users have left the room after the usage time, the management server 1A notifies the site controller 6 of having left the room (Step ST55). After confirming that the use of the room 20 ends and the users have left the room, the management server 1A disables the unlocking key of the locking device 22 for the room 20 by the lock controller 39 (Step ST56), so that the users cannot enter the room 20 again.

After using the room 20, the customer attraction server 4A that has received the participation in the event fixes the billing amount on the basis of the billing amount set in Step ST32 and the billing amount generated thereafter (Step ST34). Further, the customer attraction server 4A transmits the fixed billing amount as the billing amount to the terminal device 3B of the user in association with the reservation information, and transmits the fixed billing amount to the site controller 6. In the site controller 6, the billing amount obtainer 64 obtains the billing amount in association with the reservation information from the customer attraction server 4A and stores it in the storage unit (Step ST45). Further, in the site controller 6, the billing amount counter 65 counts the billing amount obtained by the billing amount obtainer 64, for each user from the customer attraction servers 4A (Step ST46). That is, even when the billing amount is individually set for each user on the customer attraction servers 4A for a certain event, the billing amount obtainer 64 of the site controller 6 obtains the billing amount from the customer attraction servers 4A, and the billing amount counter 65 counts the billing amount, so that it is possible to aggregate the billing information for each user and grasp the sales amount of the event.

In this way, when the billing amount counter 65 counts the billing amount to the user, the site controller 6 transmits counting results to the management server 1A. The control unit 30 of the management server 1A calculates and charges the usage fee to the reservation person and the user by the billing manager 36 on the basis of the rental fee of the room 20 to the reservation person and the billing amount which is the participation fee for each user. That is, as in the first embodiment, the usage fee billing part 362 calculates the participation fee for each user on the basis of the participation fee for the event, the price of the provided item, or the like, and charges the participation fee to the users (Step ST24). Subsequently, the control unit 30 causes the difference settler 363 to calculate the difference obtained by subtracting the rental fee of the room 20 from the sales amount of the event, which is the total of the participation fee for the event charged to the user, and when the difference is positive, the difference is paid to the reservation person, and when the difference is negative, the difference is charged to the reservation person (Step ST25). Further, regarding the price of the provided item charged to the user, the payment process is performed in which if the provider of the provided item is the reservation person oneself, the price is paid to the reservation person, and if the provider of the provided item is the seller, the price is paid to the seller.

According to the present embodiment as described above, in addition to the effects (1) to (9) of the first embodiment, the following operations and effects can be obtained.

(10) The site controller 6 is connected to the management server 1A and the customer attraction server 4A via the Internet 5, obtains the update of the customer attraction side reservation information of the customer attraction server 4A received via the user terminal device 3B of the user, and the update of the management side reservation information of the management server 1A, by the information obtainer 61, and synchronizes the management side reservation information with the customer attraction side reservation information by the synchronization controller 62. In this way, since the site controller 6 includes the synchronization controller 62 that synchronizes the customer attraction side reservation information of all the customer attraction servers 4A and the management side reservation information of the management server 1A, it is possible to efficiently manage the user information of the user who participates in the event by the site controller 6. Therefore, it is not necessary for the management server 1A and the customer attraction server 4A to synchronize the reservation information with each other, and it is possible to suppress processing loads of the servers, and to prevent processing errors and increase certainty of the reservation by synchronizing the reservation information by the synchronization controller 62 of the site controller 6.

(11) The site controller 6 issues by the key issuer 63 the unlocking key for unlocking the locking device 22 for the room 20 to be rented, on the basis of the update of the customer attraction side reservation information, so that it is possible to issue the unlocking key to the user even for the reservation from the customer attraction server 4A that does not meet specifications of the locking device 22 for the room 20 to be rented, and to attract a wide range of users regardless of key issuance specifications of the customer attraction servers 4A.

(12) In the site controller 6, the billing amount obtainer 64 obtains the billing amount for the event which the user has applied to participate in via the customer attraction server 4A, and the billing amount counter 65 counts the obtained billing amount, so that the reservation person who is the event organizer can grasp the billing amount for each customer attraction server 4A, and can grasp the sales amount which is the total of the participation fee for the event.

Alternative Implementations

Note that the present disclosure is not limited to the above embodiments, and modifications, improvements, and the like within a range in which an object of the present disclosure can be achieved are included in the present disclosure.

For example, in the above embodiment, a case in which the room (space) 20 of the building 2 is rented as the on-demand rental facility is exemplified, but the facility to be rented in the on-demand rental facility is not limited to the conference room, the training room, and the like, and may be a tennis court, a baseball field, a stadium, a parking lot, or the like, which are outdoor spaces, or a karaoke room, a rental office, a reading space, or the like. Further, the on-demand rental facility is not limited to a facility attached to real estate such as the building 2, and may be movable property such as various goods, or a moving object such as an automobile or a ship may be rented as the facility.

In the above embodiment, a case where the management servers 1 and 1A include the server device, that is connected to the terminal device 3, the communication terminal device 23, and the like, via the Internet 5 which is the communication line is exemplified, but the management servers are not limited to that including such a centralized management type server device. That is, the management server may be a distributed management type server, for example, a server using a distributed transaction ledger typified by blockchain can be used, and any server that can manage the reservation information, and can transmit and receive various commands to and from the terminal device 3 and the like, and process the commands can be used. Further, in the above embodiment, the management servers 1 and 1A and the reservation site 4 or the customer attraction server 4A are separately provided and connected to each other via the Internet 5, but the present disclosure is not limited to this, and the management servers 1 and 1A and the reservation site 4 or the customer attraction server 4A may be provided in a single site, or a function of the management server and a function of the reservation site may be implemented by a plurality of devices distributed on the Internet.

In the above embodiment, the control unit 30 of the management servers 1 and 1A includes the facility allocator 33, and the facility allocator 33 automatically updates the allocation information 431, however, the allocation information 431 may not be automatically updated by such a facility allocator 33, but may be manually updated by the administrator or the like. Further, the facility allocator 33 of the control unit 30 allocates a part of all the rooms 20 in the same building 2 when updating the allocation information 431 according to change in the number of users, but the present disclosure is not limited to this, and a room 20 of another building 2 existing in the vicinity may be allocated. As such another building 2, an owner and the administrator may be the same or different, and it may be an operation form in which a plurality of owners (administrators) cooperates to rent the rooms 20 of the building 2.

Further, in the above embodiment, the control unit 30 of the management server 1 includes the location information notifier 322 that transmits the location information 411 related to the room 20 and the building 2 included in the event holding information 422 to the user terminal device 3B, however, the location information 411 may not be transmitted to the user terminal device 3B, but may be posted on a predetermined site, or may be displayed by the message viewer 373. Further, the control unit 30 includes the registration receiver 351 that receives the registration of the provided item information 451 from the reservation person and the application receiver 352 that receives the application for the use of the provided item from the user, but functions related to the registration and the application of the provided item may be provided not in the management server 1 but in an external server (for example, a site of the seller) or the like, and the management server 1 may simply notify the user of an access procedure to the external server. Furthermore, the control unit 30 includes the message viewer 373 that allows both the reservation person and the users to view the message received by the reservation person side receiver 371 and the user side receiver 372, but functions related to the reception and the viewing may be provided not in the management server 1 but in the external server or the like, and the management server 1 may simply notify the user of the access procedure to the external server.

Further, in the above embodiment, the control unit 30 of the management server 1 includes the usage fee billing part 362 that charges the usage fee of the event for each user with respect to the users of the event to be held using the room 20, but a function related to billing of the usage fee of the event may be provided not in the management server 1 but in the external server or the like. Further, the control unit 30 includes the difference settler 363 that settles the difference obtained by subtracting the usage fee of the room 20 from the sales amount of the event, for the reservation person who is the event organizer, but such a settlement function may be omitted, or may be provided in the external server or the like. Furthermore, in the second embodiment, the billing amount counter 65 of the site controller 6 counts the billing amount for the event, but such a billing amount counting function may be provided in the management server 1A, or may be provided in the external server or the like.

Further, in the second embodiment, a configuration in which the customer attraction servers 4A receive the participation applications from the users who intend to participate in the event has been described, but it may be configured such that the reservation person who is the event organizer uses the customer attraction servers 4A when reserving the room 20 which is the facility. That is, it may be configured such that the customer attraction server 4A receives the room information, the billing conditions, and the like of the available rooms 20 from the management server 1A and the site controller 6, and discloses the room information and the billing information, and upon receiving the reservation of the room 20 from the reservation person, the customer attraction server 4A transmits the reservation information to the site controller 6 and the management server 1A. Then, the site controller 6 obtains by the information obtainer 61 the update of the customer attraction side reservation information of the customer attraction server 4A related to the reservation of the room 20 received from the reservation person and the update of the management side reservation information of the management server 1A, and synchronizes the management side reservation information with the customer attraction side reservation information by the synchronization controller 62. By synchronizing the reservation information related to the reservation of the room 20 by the site controller 6 in this way, it is possible to prevent double booking of the reservation of the room 20 and suppress the processing load of the management server 1A.

As described above, the present disclosure can be suitably used for the on-demand rental facility that can improve the operational efficiency of the facility by improving the convenience for both the reservation person and the user.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

1. An on-demand rental facility in which a usage time is set and a facility is rented, comprising
a management server connected to a communication line to manage information of the on-demand rental facility, wherein
the management server is connected via the communication line to a reservation person input means that receives information input from a reservation person of the facility to the management server and a user input means that receives information input from a user of the facility to the management server, and comprises:
a storage that stores event holding information on a reserved date and time and a reserved location of an event to be held using the facility;
a reservation person receiver that receives the event holding information via the reservation person input means, to cause the storage to store the event holding information;
a user receiver that receives user information on the user of the event related to the event holding information via the user input means, to cause the storage to store the user information; and
a user notifier that notifies the user that the user information has been received.

2. The on-demand rental facility according to claim 1, wherein
the facility is a predetermined space, and
the management server comprises a user key issuer that issues an unlocking key for unlocking a locking device for the space to the user.

3. The on-demand rental facility according to claim 1, wherein the management server comprises a location information notifier that notifies the user of location information related to a reserved location included in the event holding information stored in the storage.

4. The on-demand rental facility according to claim 1, wherein
the management server comprises:
a registration receiver that receives registration of provided item information on a provided item provided at the event related to the event holding information via the reservation person input means, to cause the storage to store the provided item information; and
an application receiver that receives an application for use of the provided item related to the provided item information via the user input means.

5. The on-demand rental facility according to claim 1, wherein
the management server comprises:
a reservation person side receiver that receives a message of the reservation person via the reservation person input means;
a user side receiver that receives a message of the user via the user input means; and
a message viewer that allows both the reservation person and the user to view the message received by the reservation person side receiver and the user side receiver.

6. The on-demand rental facility according to claim 1, wherein the management server comprises a usage fee billing part that charges a usage fee for each user with respect to users of the event related to the event holding information.

7. The on-demand rental facility according to claim 6, wherein the management server comprises a difference settler that settles a difference obtained by subtracting the usage fee of the facility from sales amount of the event, for the reservation person of the event related to the event holding information.

8. The on-demand rental facility according to claim 1, wherein
the user receiver causes the storage to store the number of people information including the number of users of the event related to the event holding information, and
the management server comprises a facility allocator that sets allocation information of the facility on the basis of the event holding information and the number of people information, and causes the user notifier to notify the user of the set allocation information.

9. The on-demand rental facility according to claim 8, wherein the facility allocator allocates at least a part of all available facilities on the basis of the event holding information, the number of people information, and the allocation information, and updates the allocation information on the allocated facility.

10. The on-demand rental facility according to claim 1, wherein
the management server is connected via the communication line to a plurality of customer attraction servers that attracts users of the event related to the event holding information and an intermediate server that aggregates customer attraction side reservation information obtained by the customer attraction servers,
the customer attraction server includes a customer attraction side reservation part that manages the customer attraction side reservation information on the user and the reserved date and time received from the user,
the management server manages the customer attraction side reservation information as the user information, the customer attraction side reservation information being received by the user receiver via the customer attraction server and the intermediate server, and
the intermediate server comprises:
an information obtaining means that obtains update of the customer attraction side reservation information of the customer attraction server and update of the user information of the management server; and
a synchronization control means that synchronizes the customer attraction side reservation information of the customer attraction server and the user information of the management server on the basis of the customer attraction side reservation information and user information obtained by the information obtaining means.

11. The on-demand rental facility according to claim 10, wherein
the facility is a predetermined space, and
the intermediate server comprises a user key issuer that issues an unlocking key for unlocking a locking device for the space when the update of the customer attraction side reservation information is obtained.

12. The on-demand rental facility according to claim 10, wherein
the intermediate server comprises:
a billing amount obtaining means that obtains a usage fee with respect to the user of the event received via the customer attraction server; and
a billing amount counting means that counts the usage fee obtained by the billing amount obtaining means.
